(19) United States
(12) Patent Application Publication
(10) Pub. No.: US 2015/0163513 A1
(43) Pub. Date: Jun. 11, 2015

(54) METHOD AND APPARATUS FOR TRANSMITTING AND RECEIVING HIGH-DEFINITION CONTENTS

(71) Applicant: Electronics and Telecommunications Research Institute, Daejeon (KR)

(72) Inventors: Kug Jin YUN, Daejeon (KR); Won-Sik CHEONG, Daejeon (KR); Gwang Soon LEE, Daejeon (KR); Namho HUR, Daejeon (KR); Juseop SIM, Seoul (KR)

(21) Appl. No.: 14/560,459

(22) Filed: Dec. 4, 2014

(30) Foreign Application Priority Data
Dec. 6, 2013 (KR) 10-2013-0151680

(51) Int. Cl. H04N 19/597; H04N 19/517

(52) U.S. Cl. CPC H04N 19/597; H04N 19/517

(57) ABSTRACT

A method and apparatus for dividing high-definition contents into two portions, encoding each portion into a dual stream of a 3D TV broadcasting system, and transmitting high-definition contents through the encoded dual stream, and a method of receiving high-definition contents that can generate high-definition contents by decoding a dual stream and combining the decoded each stream, are provided.

### CROSS-REFERENCE TO RELATED APPLICATION

This application claims priority to and the benefit of Korean Patent Application No. 10-2013-0151680 filed in the Korean Intellectual Property Office on Dec. 6, 2013, the entire contents of which are incorporated herein by reference.

### BACKGROUND OF THE INVENTION

(a) Field of the Invention

The present invention relates to a method and apparatus for transmitting and receiving high-definition contents through a broadcasting system using a dual stream.

(b) Description of the Related Art

A digital broadcasting service using a dual stream includes a 3DTV broadcasting service as a representative digital broadcasting service. In order to guarantee backward compatibility with an existing digital TV (DTV), a presently projecting 3DTV broadcasting system forms 3D contents into two streams of an image for a left eye and an image for a right eye. A dual stream method encodes each of an image for a left eye and an image for a right eye with different specifications and bit per second (bps). Tables 1 to 3 represent a portion of ATSC A/104 standard and ISO/IEC 13818-1:2013 of Advanced Television Systems Committee (ATSC), which is a US digital broadcasting standardization committee.

As can be seen in Tables 1 to 3, by applying ISO/IEC 13818-1:2013, an ATSC A/104 standard defines a base view of a stream type to 0x02 (MPEG-2) and defines an additional view to 0x23 (MPEG-4 AVC/H.264). 3D related information is identified using a stereoscopic_program_info_descriptor and a stereoscopic_video_info_descriptor.

TABLE 1
ATSC A104 standard

4.6.1 PSI
4.6.1.1 stream_type
The base view of SCHC service shall be signaled using stream_type value 0x02
and the additional
view of SCHC service shall be signaled using stream_type value 0x23 as defined
in [9].
4.6.1.2 Program and Program Element Descriptors
The Stereoscopic_program_info_descriptor( ) and
Stereoscopic_video_info_descriptor( ) as specified in [9]
shall be used in signaling of SCHC program. ATSC A/104:2012 3D-TV Terrestrial
Broadcasting, Part 2 26 December 2012
10
4.6.1.2.1 Stereoscopic_program_info_descriptor
Stereoscopic_program_info_descriptor( ) as specified in [9] shall be present in the
loop following
program_info_length field in the PMT to signal the existence of an SCHC
program. For SCHC
service, the stereoscopic_service_type shall be set to ‘011’
The stereoscopic_service_type can be set to ‘011’ to indicate that the base view
and the
additional view video elementary streams of the SCHC program are carrying the
same video.
4.6.1.2.2 Stereoscopic_video_info_descriptor
Stereoscopic_video_info_descriptor( ) as specified in [9] shall be present in the
loop following
ES_info_length field in the PMT to identify the view component of an SCHC
program; i.e., the base
view video stream and the additional view video stream.
The values of horizontal_upsampling_factor and vertical_upsampling_factor shall
be used to signal the up-sampling factor of the additional view video.

TABLE 2
ISO/IEC 13818-1:2013

| Value | Description |
|---|---|
| 0x00 | ITU-T \| ISO/IEC Reserved |
| 0x01 | ISO/IEC 11172-2 Video |
| 0x02 | Rec. ITU-T H.262 \| ISO/IEC 13818-2 Video or ISO/IEC 11172-2 constrained |
| | parameter video stream (see note 1) |
| 0x03 | ISO/IEC 11172-3 Audio |
| 0x04 | ISO/IEC 13818-3 Audio |
| 0x05 | Rec. ITU-T H.222.0 \| ISO/IEC 13818-1 private_sections |
| 0x06 | Rec. ITU-T H.222.0 \| ISO/IEC 13818-1 PES packets containing private data |
| 0x07 | ISO/IEC 13522 MHEG |
| 0x08 | Rec. ITU-T H.222.0 \| ISO/IEC 13818-1 Annex A DSM-CC |
| 0x09 | Rec. ITU-T H.222.1 |
| 0x0A | ISO/IEC 13818-6 type A |
| 0x0B | ISO/IEC 13818-6 type B |
| 0x0C | ISO/IEC 13818-6 type C |
| 0x0D | ISO/IEC 13818-6 type D |
| 0x0E | Rec. ITU-T H.222.0 \| ISO/IEC 13818-1 auxiliary |
| 0x0F | ISO/IEC 13818-7 Audio with ADTS transport syntax |
| 0x10 | ISO/IEC 14496-2 Visual |
| 0x11 | ISO/IEC 14496-3 Audio with the LATM transport syntax as defined in ISO/IEC |
| | 14496-3 |
| 0x12 | ISO/IEC 14496-1 SL-packetized stream or FlexMux stream carried in PES |
| | packets |
| 0x13 | ISO/IEC 14496-1 SL-packetized stream or FlexMux stream carried in ISO/IEC |
| | 14496_sections |
| 0x14 | ISO/IEC 13818-6 Synchronized Download Protocol |
| 0x15 | Metadata carried in PES packets |
| 0x16 | Metadata carried in metadata_sections |
| 0x17 | Metadata carried in ISO/IEC 13818-6 Data Carousel |
| 0x18 | Metadata carried in ISO/IEC 13818-6 Object Carousel |
| 0x19 | Metadata carried in ISO/IEC 13818-6 Synchronized Download Protocol |
| 0x1A | IPMP stream (defined in ISO/IEC 13818-11, MPEG-2 IPMP) |
| 0x1B | AVC video stream conforming to one or more profiles defined in Annex A of Rec. |
| | ITU-T H.264 \| ISO/IEC 14496-10 or AVC video sub-bitstream as defined in 2.1.78 |
| | or MVC base view sub-bitstream as defined in 2.1.85 or AVC video sub-bitstream |
| | of MVC as defined in 2.1.88 |
| 0x1C | ISO/IEC 14496-3 Audio, without using any additional transport syntax, such as |
| | DST, ALS and SLS |
| 0x1D | ISO/IEC 14496-17 Text |
| 0x1E | Auxiliary video stream as defined in ISO/IEC 23002-3 |
| 0x1F | SVC video sub-bitstream of an AVC video stream conforming to one or more |
| | profiles defined in Annex G of Rec. ITU-T H.264 \| ISO/IEC 14496-10 |
| 0x20 | MVC video sub-bitstream of an AVC video stream conforming to one or more |
| | profiles defined in Annex H of Rec. ITU-T H.264 \| ISO/IEC 14496-10 |
| 0x21 | Video stream conforming to one or more profiles as defined in Rec. ITU-T T.800 \| |
| | ISO/IEC 15444-1 |
| 0x22 | Additional view Rec. ITU-T H.262 \| ISO/IEC 13818-2 video stream for |
| | service-compatible stereoscopic 3D services (see note 2 and 3) |
| 0x23 | Additional view Rec. ITU-T H.264 \| ISO/IEC 14496-10 video stream conforming to |
| | one or more profiles defined in Annex A for service-compatible stereoscopic 3D |
| | services (see note 2 and 3) |
| 0x24-0x7E | Rec. ITU-T H.222.0 \| ISO/IEC 13818-1 Reserved |
| 0x7F | IPMP stream |
| 0x80-0xFF | User Private |

TABLE 3
Program information descriptor

| Syntax | No. of bits | Format |
|---|---|---|
| Stereoscopic_program_info_descriptor( ) { | | |
| descriptor_tag | 8 | uimsbf |
| descriptor_length | 8 | uimsbf |
| reserved | 5 | bslbf |
| stereoscopic_service_type | 3 | bslbf |
| } | | |

TABLE 4
Video information descriptor

| Syntax | No. of bits | Format |
|---|---|---|
| Stereoscopic_ video_info_descriptor( ) { | | |
| descriptor_tag | 8 | uimsbf |
| descriptor_length | 8 | uimsbf |
| reserved | 7 | bslbf |
| base_video_flag | 1 | bslbf |
| if (base_video_flag) { | 7 | bslbf |
| reserved | 1 | bslbf |
| leftview_flag | 7 | bslbf |
| } else { | 1 | bslbf |
| reserved | 4 | bslbf |
| usable_as_2D | 4 | bslbf |
| horizontal_upsampling_factor | | |
| vertical_upsampling_factor | | |
| } | | |
| } | | |

Such a 3DTV broadcasting system can transmit a broadcasting signal to both a DTV user and a 3DTV user. In this case, the DTV user may receive a dual stream of the 3DTV broadcasting system to display only one stream or may receive and display a stream in which the same image is encoded in a dual stream. However, there is a problem that it is difficult to transmit high-definition 2D contents with a specification of a present broadcasting system.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and apparatus for transmitting and receiving high-definition 2D contents through a broadcasting system using a dual stream.

An exemplary embodiment of the present invention provides a method of transmitting high-definition contents to a digital television (TV). The method includes: dividing the high-definition contents into two portions; encoding the two portions into a dual stream of a broadcasting system; and transmitting the encoded dual stream.

The two portions may be an odd number field and an even number field of each frame of the high-definition contents, and the encoding of the two portions may include encoding the odd number field and the even number field into the dual stream, respectively.

The encoding of the two portions may include encoding the odd number field into a first stream of the dual stream and encoding the even number field into a second stream of the dual stream.

The encoding of the two portions may include: encoding the odd number field into a first stream of the dual stream and encoding the even number field into a second stream of the dual stream for 1/N second, when the number of frames per second (fps) of the high-definition contents is N; and encoding the even number field into the first stream and encoding the odd number field into the second stream for a next 1/N second after the 1/N second.

The two portions may be an even-numbered frame group and an odd-numbered frame group of a plurality of frames that are included in the high-definition contents, and the encoding of the two portions may include encoding the odd-numbered frame group and the even-numbered frame group into the dual stream, respectively.

The encoding of the two portions may include: encoding the odd-numbered frame group into a first stream of the dual stream and encoding the even-numbered frame group into a second stream of the dual stream for 1/N second, when the number of fps of the high-definition contents is N; and encoding the even-numbered frame group into the first stream and encoding the odd-numbered frame group into the second stream for a next 1/N second after the 1/N second

Another embodiment of the present invention provides an apparatus that transmits high-definition contents to a digital TV. The apparatus includes: a dividing device that divides the high-definition contents into two portions; an encoder that encodes the two portions into a dual stream of a broadcasting system; and a transmitter that transmits the encoded dual stream.

The two portions may be an odd number field and an even number field of each frame of the high-definition contents, and the encoder may encode the odd number field and the even number field into the dual stream, respectively.

The encoder may include a first encoder that encodes the odd number field into a first stream of the dual stream and a second encoder that encodes the even number field into a second stream of the dual stream.

The encoder may encode the odd number field into a first stream of the dual stream and encode the even number field into a second stream of the dual stream for 1/N second and encode the even number field into the first stream and encode the odd number field into the second stream for a next 1/N second after the 1/N second, when the number of frames per second (fps) of the high-definition contents is N.

The two portions may be an even-numbered frame group and an odd-numbered frame group of a plurality of frames that are included in the high-definition contents, and the encoder may encode the odd-numbered frame group and the even-numbered frame group into the dual stream, respectively.

The encoder may include: a first encoder that encodes the odd-numbered frame group into a first stream of the dual stream; and a second encoder that encodes the even-numbered frame group into a second stream of the dual stream.

The encoder may encode the odd-numbered frame group into a first stream of the dual stream and encode the even-numbered frame group into a second stream of the dual stream for 1/N second and encode the even-numbered frame group into the first stream and encode the odd-numbered frame group into the second stream for a next 1/N second after the 1/N second, when the number of fps of the high-definition contents is N.

Yet another embodiment of the present invention provides a method of receiving high-definition contents. The method includes: receiving a dual stream in which the high-definition contents are encoded; decoding the dual stream; and combining a first stream and a second stream of the decoded dual stream and generating the high-definition contents.

The first stream may include an odd number field of each frame of the high-definition contents and the second stream may include an even number field of each frame of the high-definition contents.

The first stream may include an odd number field of each frame of the high-definition contents and the second stream may include an even number field of each frame of the high-definition contents for 1/N second, and the first stream may include an even number field and the second stream may include an odd number field for a next 1/N second after the 1/N second, when the number of frames per second (fps) of the high-definition contents is N.

The first stream may include an odd numbered frame group of a plurality of frames that are included in the high-definition contents, and the second stream may include an even numbered frame group of a plurality of frames that are included in the high-definition contents.

The first stream may include an odd-numbered frame group of a plurality of frames that are included in the high-definition contents and the second stream may include an even-numbered frame group of a plurality of frames that are included in the high-definition contents for 1/N second, and the first stream may include the even-numbered frame group and the second stream may include the odd-numbered frame group for a next 1/N second after the 1/N second, when the number of fps of the high-definition contents is N.

### BRIEF DESCRIPTION OF THE DRAWINGS

FIG. 1 is a block diagram illustrating a configuration of a 3DTV broadcasting system according to an exemplary embodiment of the present invention.

FIG. 2 is a diagram illustrating a method of displaying an image signal of 30 frames in a TV in a 3DTV broadcasting system according to an ATSC standard.

FIG. 3 is a diagram illustrating a broadcasting system of a dual stream method of transmitting and receiving high-definition contents according to an exemplary embodiment of the present invention.

FIG. 4 is a diagram illustrating a broadcasting system of a dual stream method of transmitting and receiving high-definition contents according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements. In addition, the terms “-er”, “-or”, “module”, and “block” described in the specification mean units for processing at least one function and operation and can be implemented by hardware components or software components and combinations thereof.

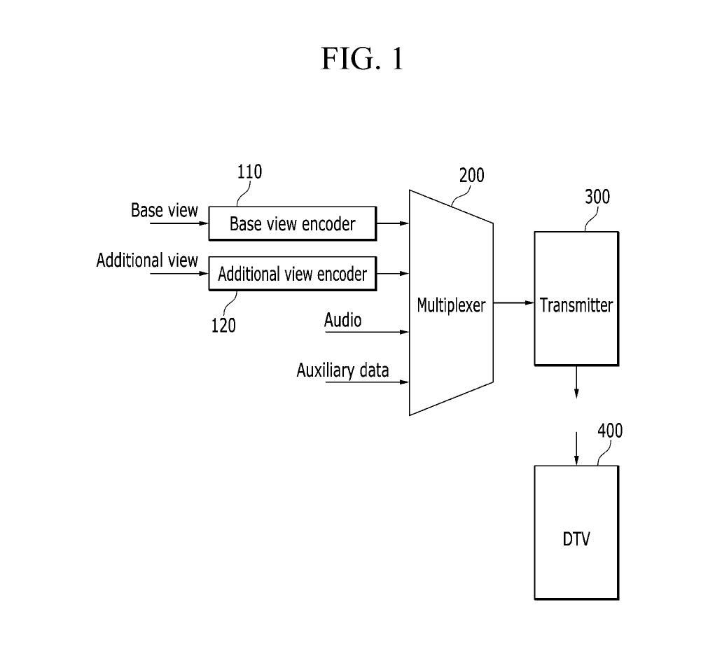

FIG. 1 is a block diagram illustrating a configuration of a 3DTV broadcasting system according to an exemplary embodiment of the present invention.

Referring to FIG. 1, a 3DTV broadcasting system according to an exemplary embodiment of the present invention includes a base view encoder 110, an additional view encoder 120, a multiplexer 200, a transmitter 300, and a DTV 400.

The base view encoder 110 encodes base view video, and the additional view encoder 120 encodes additional view video. In an exemplary embodiment of the present invention, a base view encoder and an additional view encoder may each encode high-definition contents that are divided into two portions into a dual stream of a 3DTV broadcasting system.

The multiplexer 200 multiplexes a dual stream that is encoded in the base view encoder and the additional view encoder with audio and auxiliary data.

The transmitter 300 transmits the multiplexed stream using the 3DTV broadcasting system.

The DTV 400 receives a stream of the 3DTV broadcasting system and displays contents.

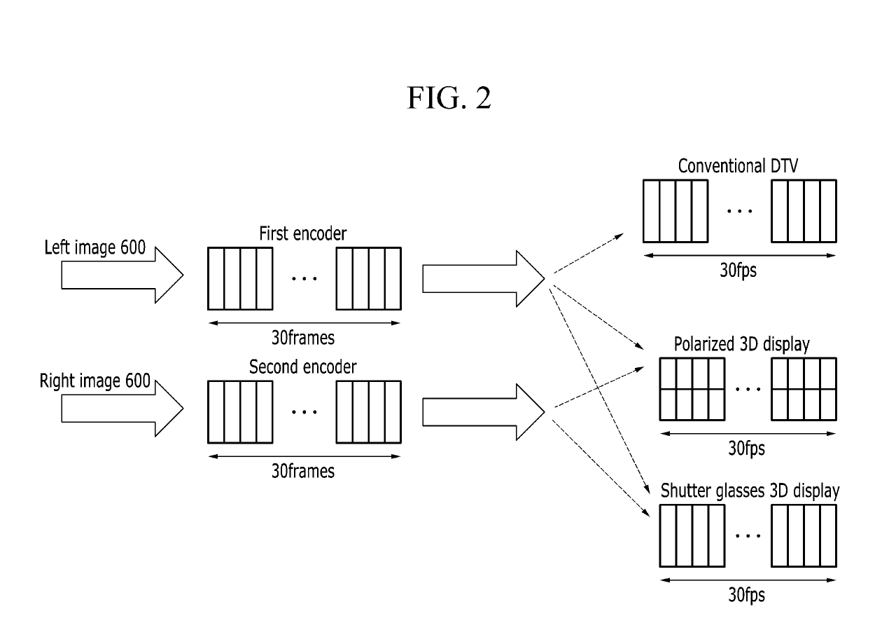

FIG. 2 is a diagram illustrating a method of displaying an image signal of 30 frames in a TV in a 3DTV broadcasting system according to an ATSC standard.

Referring to FIG. 2, the 3DTV broadcasting system encodes and transmits each of a 30 frame (60i or 30p) image for a left eye and a 30 frame image for a right eye. A conventional DTV having received the image reproduces a 30 frame image for a left eye, and a polarized 3D display may reproduce an interlace 3D image in which an image for a left eye and an image for a right eye are entirely inserted into one frame with the number of 30 frames per second (fps), while a shutter glasses 3D display may alternately reproduce an image for a left eye and an image for a right eye with 60 fps by one frame.

That is, according to an ATSC standard, a binocular 3D image is provided with a dual stream using a base view encoder and an additional view encoder. In this case, when 2D contents are provided with a method of switching and providing only a base view, an additional view encoder should be stopped, and thus when 3D contents are converted to 2D contents, screen flickering may occur. Hereinafter, a method of transmitting high-definition contents of a high frame rate to a DTV through a broadcasting system using a dual stream will be described. An image of a progressive method (1080 60p) of 60 fps and in which a longitudinal resolution is 1080 is described as an example of high-definition contents of a high frame data rate. In this case, a longitudinal resolution 1080 is a specification of a present high-definition (HD) image, and the present invention can be applied to a higher resolution and frame data rate.

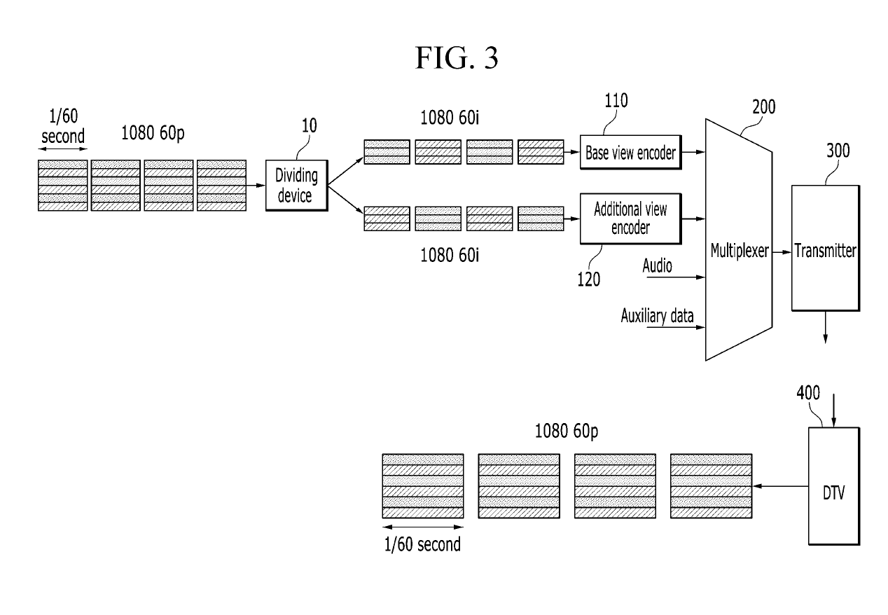

FIG. 3 is a diagram illustrating a broadcasting system of a dual stream method of transmitting and receiving high-definition contents according to an exemplary embodiment of the present invention.

Referring to FIG. 3, a 1080 60p image is acquired as high-definition contents, and the high-definition contents that are acquired in a dividing device 10 are divided. In FIG. 3, the dividing device 10 divides each frame of high-definition contents into an odd number field and an even number field.

Next, the encoders 110 and 120 encode the divided image into an image of an interlace method 60i. That is, the encoders 110 and 120 each encode high-definition contents that are divided into data (odd number field) of an odd-numbered line and data (even number field) of an even-numbered line into a dual stream of a broadcasting system in each frame.

In this case, two separated fields may each be encoded into one stream, but as shown in FIG. 3, each field may be alternately encoded into each stream. In this case, for 1/60 second, odd number fields may be encoded into a first stream and even number fields may be encoded into a second stream, and for the next 1/60 second, even number fields may be encoded into a first stream and odd number fields may be encoded into a second stream.

Thereafter, the transmitter 300 transmits the encoded dual stream to a DTV using a broadcasting system. As described above, because a broadcasting system using a dual stream can transmit two broadcasting streams, odd number fields and even number fields according to an exemplary embodiment of the present invention may be transmitted through a dual stream of a broadcasting system.

Thereafter, the DTV 400, having received a 1080 60i image through a dual stream, decodes the received dual stream and combines the decoded each stream, thereby generating one 1080 60p image. Generation of one 1080 60p image by combining the received 1080 60i image stream may be performed in a device that is located at the outside of the DTV 400, and may be performed in a processor that is included in the DTV 400.

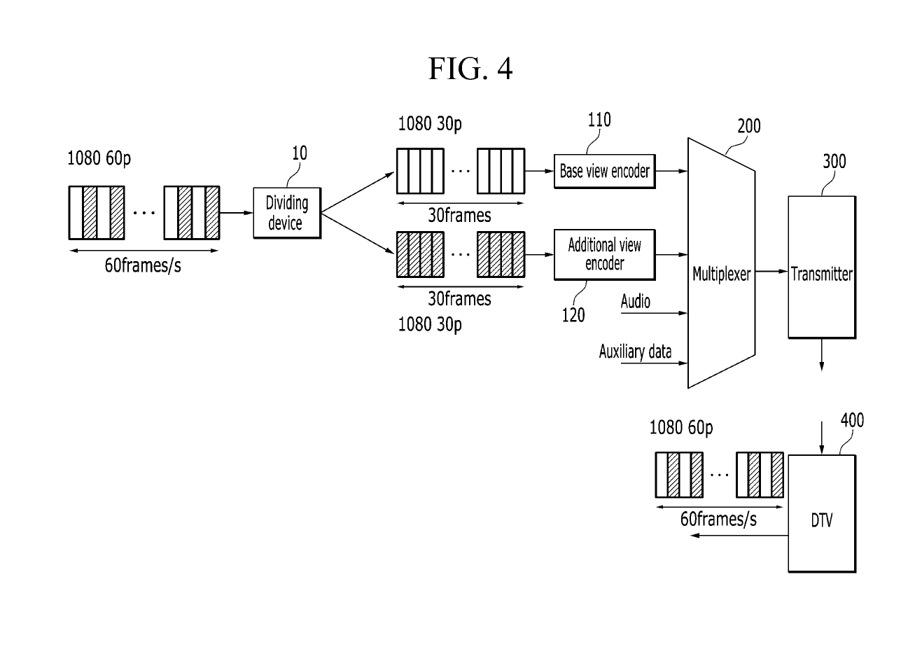

FIG. 4 is a diagram illustrating a broadcasting system of a dual stream method of transmitting and receiving high-definition contents according to another exemplary embodiment of the present invention.

Referring to FIG. 4, the dividing device 10 divides a plurality of frames that are included in high-definition contents of 1080 60p into an odd-numbered frame group and an even-numbered frame group. In this case, each frame group represents image data of 1080 30p.

Thereafter, the encoders 110 and 120 encode each divided frame group into a dual stream of a progressive method 30p.

As in an exemplary embodiment of FIG. 4, each frame group may be encoded into a single stream, and similar to an exemplary embodiment of FIG. 3, each frame group may be alternately encoded into each stream. For example, for 1/60 second, an odd-numbered frame group may be encoded into a first stream and an even-numbered frame group may be encoded into a second stream, and for the next 1/60 second, an even-numbered frame group may be encoded into a first stream and an odd-numbered frame group may be encoded into a second stream.

Thereafter, the transmitter 300 transmits a dual stream to the DTV 400. Then, the DTV 400 having received a 1080 30p image through two streams decodes the received dual stream and combines each decoded stream, thereby generating a 1080 60p image.

As described above, according to an exemplary embodiment of the present invention, because a 2D high-definition image can be transmitted to a digital TV using a dual stream of a broadcasting system, a viewer can view a 2D high-definition image through an existing digital TV.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting high-definition contents to a digital television (TV), the method comprising:
dividing the high-definition contents into two portions;
encoding the two portions into a dual stream of a broadcasting system; and
transmitting the encoded dual stream.

2. The method of claim 1, wherein the two portions are an odd number field and an even number field of each frame of the high-definition contents, and
the encoding of the two portions comprises encoding the odd number field and the even number field into the dual stream, respectively.

3. The method of claim 2, wherein the encoding of the two portions comprises encoding the odd number field into a first stream of the dual stream and encoding the even number field into a second stream of the dual stream

4. The method of claim 2, wherein the encoding of the two portions comprises:
encoding the odd number field into a first stream of the dual stream and encoding the even number field into a second stream of the dual stream for 1/N second, when the number of frames per second (fps) of the high-definition contents is N; and
encoding the even number field into the first stream and encoding the odd number field into the second stream for a next 1/N second after the 1/N second.

5. The method of claim 1, wherein the two portions are an even-numbered frame group and an odd-numbered frame group of a plurality of frames that are included in the high-definition contents, and
the encoding of the two portions comprises encoding the odd-numbered frame group and the even-numbered frame group into the dual stream, respectively.

6. The method of claim 5, wherein the encoding of the two portions comprises:
encoding the odd-numbered frame group into a first stream of the dual stream; and
encoding the even-numbered frame group into a second stream of the dual stream.

7. The method of claim 5, wherein the encoding of the two portions comprises:
encoding the odd-numbered frame group into a first stream of the dual stream and encoding the even-numbered frame group into a second stream of the dual stream for 1/N second, when the number of fps of the high-definition contents is N; and
encoding the even-numbered frame group into the first stream and encoding the odd-numbered frame group into the second stream for a next 1/N second after the 1/N second.

8. An apparatus that transmits high-definition contents to a digital TV, the apparatus comprising:
a dividing device that divides the high-definition contents into two portions;
an encoder that encodes the two portions into a dual stream of a broadcasting system; and
a transmitter that transmits the encoded dual stream.

9. The apparatus of claim 8, wherein the two portions are an odd number field and an even number field of each frame of the high-definition contents, and
the encoder encodes the odd number field and the even number field into the dual stream, respectively.

10. The apparatus of claim 9, wherein the encoder comprises a first encoder that encodes the odd number field into a first stream of the dual stream and a second encoder that encodes the even number field into a second stream of the dual stream

11. The apparatus of claim 9, wherein the encoder encodes the odd number field into a first stream of the dual stream and encodes the even number field into a second stream of the dual stream for 1/N second and encodes the even number field into the first stream and encodes the odd number field into the second stream for a next 1/N second after the 1/N second, when the number of frames per second (fps) of the high-definition contents is N.

12. The apparatus of claim 8, wherein the two portions are an even-numbered frame group and an odd-numbered frame group of a plurality of frames that are included in the high-definition contents, and
the encoder encodes the odd-numbered frame group and the even-numbered frame group into the dual stream, respectively.

13. The apparatus of claim 12, wherein the encoder comprises:
a first encoder that encodes the odd-numbered frame group into a first stream of the dual stream; and
a second encoder that encodes the even-numbered frame group into a second stream of the dual stream.

14. The apparatus of claim 12, wherein the encoder encodes the odd-numbered frame group into a first stream of the dual stream and encodes the even-numbered frame group into a second stream of the dual stream for 1/N second and encodes the even-numbered frame group into the first stream and encodes the odd-numbered frame group into the second stream for a next 1/N second after the 1/N second, when the number of fps of the high-definition contents is N.

15. A method of receiving high-definition contents, the method comprising:
receiving a dual stream in which the high-definition contents are encoded;
decoding the dual stream; and
combining a first stream and a second stream of the decoded dual stream and generating the high-definition contents.

16. The method of claim 15, wherein the first stream comprises an odd number field of each frame of the high-definition contents and the second stream comprises an even number field of each frame of the high-definition contents.

17. The method of claim 15, wherein the first stream comprises an odd number field of each frame of the high-definition contents and the second stream comprises an even number field of each frame of the high-definition contents for 1/N second, and the first stream comprises an even number field and the second stream comprises an odd number field for a next 1/N second after the 1/N second, when the number of frames per second (fps) of the high-definition contents is N.

18. The method of claim 15, wherein the first stream comprises an odd-numbered frame group of a plurality of frames that are included in the high-definition contents, and the second stream comprises an even-numbered frame group of a plurality of frames that are included in the high-definition contents.

19. The method of claim 15, wherein the first stream comprises an odd-numbered frame group of a plurality of frames that are included in the high-definition contents and the second stream comprises an even-numbered frame group of a plurality of frames that are included in the high-definition contents for 1/N second, and the first stream comprises the even-numbered frame group and the second stream comprises the odd-numbered frame group for a next 1/N second after the 1/N second, when the number of fps of the high-definition contents is N.
